(19) United States
(12) Patent Application Publication
(10) Pub. No.: US 2005/0034747 A1
(43) Pub. Date: Feb. 17, 2005

(54) Fluid injector for treating surface of flat display panel

(76) Inventors: Yong-Seok Park, Seoul (KR); Kyoung-Heon Heo, Hwasung-city (KR); Seung-Won Lee, Goyang-city (KR)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/864,994

(22) Filed: Jun. 10, 2004

(30) Foreign Application Priority Data
Jun. 27, 2003 (KR) 10-2003-0042580

(51) Int. Cl. B08B 3/02

(52) U.S. Cl. 134/115 R; 134/198; 134/184; 239/589

(57) ABSTRACT

A fluid injector for treating a surface of a flat display panel includes a case provided with a cavity for receiving fluid; a pair of nozzle guiders coupled to the case and disposed facing each other; a gap-adjusting plate disposed between the nozzle guiders to adjust a gap between the nozzle guiders; and a coupling device for coupling the nozzle guiders to the gap-adjusting plate.

### BACKGROUND OF THE DISCLOSURE

1. Field of the Disclosure

The disclosure relates to a fluid injector, and more particularly to a fluid injector that can be used to treat a surface of a flat display panel, and that improves injection precision.

2. Description of Related Art

Generally, a fluid injector used for treating a surface of a flat display panel is formed having a length greater than a width of the panel, and is provided with a nozzle having an uneven surface. However, the uneven surface makes it difficult to uniformly treat an inner surface of the panel. Furthermore, when intervals between the nozzles are not uniform, the injection precision is deteriorated.

In addition, the conventional fluid injector has a drawback in that pressures of the injection nozzles are not uniform, so the surface of the panel cannot be precisely processed.

Furthermore, due to the length of the injection nozzle, the dispensing and flow rate of the fluid are not uniformly realized in the course of injecting the fluid.

### SUMMARY OF THE DISCLOSURE

Accordingly, the disclosure is directed to a fluid injector that substantially obviates one or more problems due to limitations and disadvantages of the related art.

The disclosure provides a fluid injector for treating a surface of a flat display panel that can enhance injection precision by uniformly forming an interval between nozzles.

The disclosure further provides a fluid injector for treating a flat display panel that can improve injection precision by uniformly forming fluid pressure at the nozzles.

The disclosure further provides a fluid injector for treating a flat display panel that can improve injection precision by not being affected by the length of a nozzle, thereby providing uniform fluid dispensing.

In one embodiment according to the disclosure, a fluid injector for treating a surface of a flat display panel includes a case provided with a cavity for receiving fluid; a pair of nozzle guiders coupled to the case and disposed facing each other; a gap-adjusting plate disposed between the nozzle guiders to adjust a gap between the nozzle guiders; and a coupling connecting the nozzle guiders to the gap-adjusting plate.

According to another embodiment, the disclosure provides a fluid injector for treating a surface of a flat display panel including a case provided with a cavity for receiving fluid, and a nozzle guider coupled to the case, the nozzle guider defining a nozzle portion and a pressure-adjusting cavity where pressure of the fluid is adjusted before being injected through the nozzle portion.

According to still another embodiment, the disclosure provides a fluid injector for treating a surface of a flat display panel including a case provided with a cavity for receiving fluid, a nozzle guider coupled to the case to define a nozzle portion, and a tube disposed in the cavity of the case to receive fluid from a fluid-supplying apparatus, the tube being provided with a plurality of exhaust holes arranged at predetermined intervals.

Both the foregoing general description and the following detailed description are exemplary and explanatory, and are intended to provide further explanation of the invention as claimed.

### BRIEF DESCRIPTION OF THE DRAWINGS

The accompanying drawings are incorporated in and constitute a part of this disclosure, and illustrate embodiments of the disclosed fluid injectors, and together with the description serve to explain the principles thereof. In the drawings:

FIG. 1 is a perspective view of a fluid injector according to a preferred embodiment of the disclosure;

FIG. 2 is a sectional view taken along line A-A of FIG. 1; and

FIG. 3 is a sectional view taken along line B-B of FIG. 1.

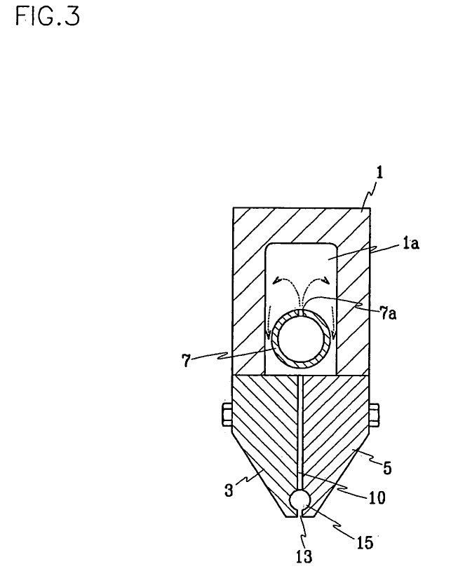

### DETAILED DESCRIPTION

Reference will now be made in detail to the preferred embodiments of the fluid injector, examples of which are illustrated in the accompanying drawings. Wherever possible, the same reference numbers will be used throughout the drawings to refer to the same or like parts.

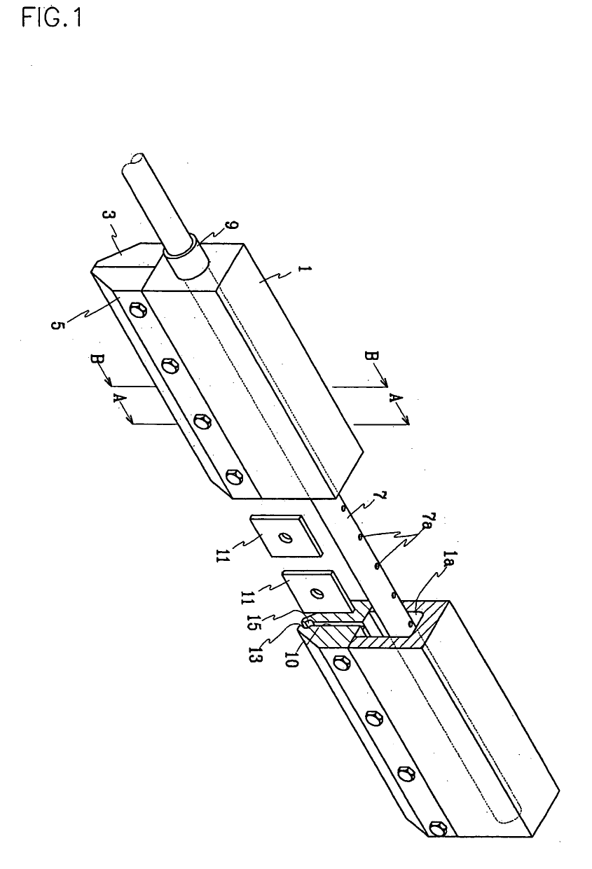

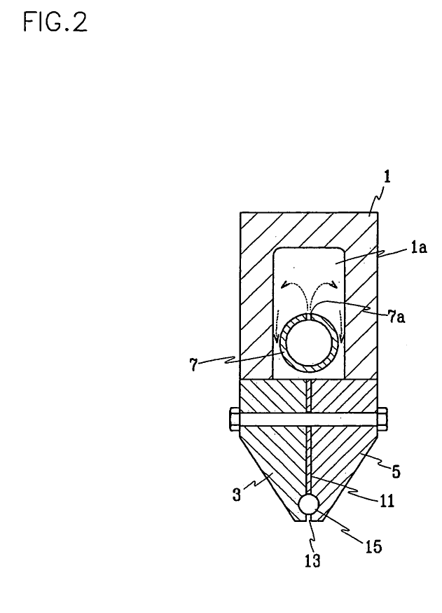

FIGS. 1 and 2 show a fluid injector including a case 1, nozzle guiders 3 and 5 coupled to the case 1, and a tube 7 disposed in a cavity 1a defined by the case 1. The fluid can be liquid agents or fresh air, for example.

The case 1 and the cavity 1a are formed in a longitudinal direction. The tube 7 is disposed in the cavity 1a to receive the fluid from a separate fluid-supplying device (not shown). That is, the fluid is introduced into the case through a fitting 9 fitted on a side end of the case. The tube 7 may be omitted if required. That is, the fluid can be directly fed to the cavity 1a defined by the case 1. The tube 7 is provided with exhaust holes 7a formed upwardly at predetermined intervals, and the exhaust holes 7a allow the fluid introduced horizontally to be directed into the cavity 1a of the case 1 in a vertical direction.

The nozzle guiders 3 and 5 are paired, having opposing surfaces treated so that they are not uneven. A plurality of gap-adjusting plates 11 are disposed between the nozzle guiders 3 and 5. Passages 10 are defined by the gap-adjusting plates 11 and the nozzle guiders 3 and 5, communicating with the cavity 1a of the case 1 and allowing the fluid to be directed to a nozzle portion 13 formed by the nozzle guiders 3 and 5.

The nozzle guiders 3 and 5 and the gap-adjusting plate 11 are coupled to each other by a fastener such as a bolt and nut, or a screw.

A pressure control cavity 15 is provided between the nozzle guiders 3 and 5 near the nozzle portion 13 to spray the fluid through the nozzle portion 13 at a uniform pressure. The fluid introduced into the tube 7 is uniformly adjusted in pressure while being directed to the cavity 1a through the exhaust holes 7a.

The fluid flow process is described in more detail below.

When the fluid is supplied from the fluid supply device (not shown) to a side of the case 1, the fluid is introduced into the tube 1 in a horizontal direction and is then exhausted to the cavity 1a of the case 1 through the exhaust hole 7a in a vertical direction, in the course of which the pressure of the fluid is uniformly adjusted while a flowing direction thereof is changed. As a result, the fluid is sprayed through the nozzle portion 13 along the passages 10 defined by the nozzle guiders 3 and 5 and the gap-adjusting plates 11. At this point, since the pressure control cavity 15 is provided near the nozzle portion 13, the fluid is temporarily collected in the cavity 15 to uniformly adjust the pressure. The adjusted fluid is uniformly sprayed through the nozzle portion 13.

As described above, since a gap of the nozzle portion 13 is adjusted by the gap-adjusting plates 11, the opposing surfaces of the nozzle guiders 3 and 5 can be easily treated, thereby reducing manufacturing costs. In addition, since the pressure of the fluid is uniformly adjusted while passing through the cavity 1a and the pressure-adjusting cavity 15, the fluid can be sprayed at a uniform pressure even when the nozzle portion 13 is lengthened. As a result, the injection precision of the fluid is improved to ideally perform the surface treatment of the flat display panel. Furthermore, since the fluid is uniformly injected, it is possible to reduce the amount of fluid used.

Since it is easy to manufacture the relatively lengthened nozzle, manufacturing costs can be minimized. In addition, since the nozzle portion has a uniform gap, the fluid injection precision can be improved.

Furthermore, since the exhaust holes are formed to be vertical to the fluid inlet direction, the pressure and speed of the fluid can be uniformly adjusted while it changes its flowing direction, so the fluid injection precision can be further improved.

In addition, pressure of the fluid can be adjusted by the pressure-adjusting cavity immediately before it is injected through the nozzle portion, so the fluid injection precision can be further improved.

It will be apparent to those skilled in the art that various modifications and variations can be made in the disclosed fluid injector. Thus, the disclosure covers the modifications and variations of this invention provided they fall within the scope of the appended claims and their equivalents.

1. A fluid injector for treating a surface of a flat display panel, comprising:
a case provided with a cavity for receiving fluid;
a pair of nozzle guiders coupled to the case and disposed facing each other;
a gap-adjusting plate disposed between the nozzle guiders to adjust a gap between the nozzle guiders; and
a couple device for coupling the nozzle guiders to the gap-adjusting plate.

2. The fluid injector of claim 1, further comprising a tube disposed in the cavity of the case to receive fluid from a fluid-supplying apparatus, the tube being provided with a plurality of exhaust holes arranged at predetermined intervals.

3. The fluid injector of claim 2, wherein the fluid exhaust holes are formed such that they can exhaust fluid in a direction opposite to a direction where the fluid is injected.

4. The fluid injector of claim 1, wherein the nozzle guiders define a nozzle portion and a pressure-adjusting cavity where pressure of the fluid is adjusted before being injected through the nozzle portion.

5. The fluid injector of claim 1, wherein the nozzle guiders that are paired are coupled by coupling means, and a plurality of gap-adjusting plates are disposed between the paired nozzle guiders.

6. The fluid injector of claim 1, wherein the coupling means is selected from the group consisting of a bolt/nut assembly, and a screw.

7. A fluid injector for treating a surface of a flat display panel, comprising:
a case provided with a cavity for receiving fluid; and
a nozzle guider coupled to the case, the nozzle guider defining a nozzle portion and a pressure-adjusting cavity where pressure of the fluid is adjusted before being injected through the nozzle portion.

8. The fluid injector of claim 7, further comprising a tube disposed in the cavity of the case to receive fluid from a fluid-supplying apparatus, the tube being provided with a plurality of exhaust holes arranged at predetermined intervals.

9. The fluid injector of claim 8, wherein the fluid exhaust holes are formed such that they can exhaust fluid in a direction opposite to a direction where the fluid is injected.

10. A fluid injector for treating a surface of a flat display panel, comprising:
a case provided with a cavity for receiving fluid;
a nozzle guider coupled to the case to define a nozzle portion; and
a tube disposed in the cavity of the case to receive fluid from a fluid-supplying apparatus, the tube being provided with a plurality of exhaust holes arranged at predetermined intervals.

11. The fluid injector of claim 10, wherein the nozzle guiders define a nozzle portion and a pressure-adjusting cavity where pressure of the fluid is adjusted before being injected through the nozzle portion.

12. The fluid injector of claim 10, wherein the nozzle guiders that are paired are coupled by coupling means, and a plurality of gap-adjusting plates are disposed between the paired nozzle guiders.
